(19) United States
(12) Patent Application Publication
(10) Pub. No.: US 2007/0159996 A1
(43) Pub. Date: Jul. 12, 2007

(54) Wireless internet access repeater and method thereof

(76) Inventors: In-Soo PARK, Incheon-city (KR); Jong-Seong Koh, Seongnam City (KR); Yong-Bum Kim, Seoul (KR)

Correspondence Address: JONES DAY, 222 EAST 41ST ST, NEW YORK, NY, 10017, US

(21) Appl. No.: 10/565,820

(22) PCT Filed: Jul. 23, 2004
(86) PCT No.: PCT/KR04/01861

§ 371 Date: Sep. 7, 2006

(30) Foreign Application Priority Data
Jul. 23, 2003 (KR) 10-2003-0050597

(51) Int. Cl. H04Q 7/00; H04J 3/16

(52) U.S. Cl. 370/328; 370/466

(57) ABSTRACT

Disclosed is a wireless Internet access repeater and method thereof. When a user terminal is located in a blanket area, the wireless Internet access repeater receives first communication type signals in a first frequency band from a wireless Internet access network. The received signals are converted into a second communication type format, are processed to be signals in a second frequency band, and are transmitted to the user terminal. The repeater receives the second communication type signals in the second frequency band from the user terminal, converts the received signals into a first communication type format, processes the converted signals to be the first communication type signals in the first frequency band, and transmits them to the wireless Internet access network. Hence, the user can receive a wireless Internet service and multimedia services without interference between the signals with the same frequency in the blanket are.

### BACKGROUND OF THE INVENTION

(a) Field of the Invention

The present invention relates to a repeater and method thereof. More specifically, the present invention relates to a wireless Internet access repeater and method thereof.

(b) Description of the Related Art

As wireless communication techniques have developed, wireless Internet services have been provided to users so that the users who are moving to another place or stand still may respectively use a wireless terminal, access Internet services, and multimedia services such as video and audio services through wireless networks, and receive desired information.

The users conventionally use the wireless terminal and receive the Internet service through the wireless Internet network while they are stopped or traveling. The above-noted service allows the users to use various categories of information and contents at high data rates in many wireless access environments including the mobile communication, the IMT-2000, the portable Internet, and the fourth-generation mobile communication environments.

The wireless local area network (WLAN) allows the users to advantageously use the wireless very fast Internet with low fees, but it has restriction of movement since it is used in a specific area, and it only covers several tens of subscribers for each specific area.

Basements of huge buildings and rooms of tall buildings have blanket areas in which no service is available even though the wireless networks such as the mobile communication, the IMT-2000, the portable Internet, and the fourth-generation mobile communication cover the whole city because of arrangements of a lot of base stations. The users accordingly fail to receive the wireless Internet service because of generation of the blanket areas.

To solve the problem, repeaters are conventionally used to extend service available coverage. However, since the conventional repeaters amplify weak signals provided by the base station and transmit them, the repeated frequency and the serviced frequency between the base station and the repeater are the same, and hence, an oscillation phenomenon or inter-signal interference is generated in the repeater.

### SUMMARY OF THE INVENTION

It is an advantage of the present invention to allow the user to receive an Internet service, and multimedia services including video and audio services, through wireless Internet access repetition without interference between signals in a blanket area.

In one aspect of the present invention, in a device for repeating a wireless Internet access of a user terminal between a wireless Internet access network and the user terminal, a wireless Internet access repeater comprises: a first transmit and receive unit for transmitting and receiving signals to/from the wireless Internet access network by a first communication type; a second transmit and receive unit for transmitting and receiving signals to/from the user terminal by a second communication type; and a media access control (MAC) conversion manager for processing data included in the first communication type signal input by the first transmit and receive unit into a second communication type format, transmitting the second communication type format data to the second transmit and receive unit, processing data included in the second communication type signal input by the second transmit and receive unit into a first communication type format, and transmitting the first communication type format data to the first transmit and receive unit.

The wireless Internet access repeater further comprises an operation controller for controlling the MAC conversion manager and controlling transmitting and receiving repetition of the signals which are transmitted according to the first and second communication types.

The MAC conversion manager comprises: a frame monitor for managing order information of the same data frame according to header information of the data frame included in the signals received by the first or second transmit and receive unit; a frame processor for converting the data frame into a format which follows a MAC structure corresponding to a desired communication type; a channel controller for controlling a modulation rate and a bit rate of the transmitted data frame according to the communication type; and a standby manager for controlling data rates according to the established modulation rate and the bit rate, and it further comprises: a channel allocator for allocating a channel to the data frame included in the signal received through the second transmit and receive unit; and a channel manager for managing channel allocation information and channel states.

In another aspect of the present invention, in a method for repeating a wireless Internet access of a user terminal between a wireless Internet access network and the user terminal, a wireless Internet access repetition method comprises: (a) receiving a signal in a first frequency band following a first communication type and being transmitted from the wireless Internet access network; (b) converting the received signal into a second communication type format; (c) processing the converted signal into a signal in a second frequency band following the second communication type, and transmitting the processed signal to the user terminal; (d) receiving a signal in a second frequency band following the second communication type and being transmitted from the user terminal; (e) converting the received signal into the first communication type format; and (f) processing the converted signal into a signal in the first frequency band according to the first communication type, and transmitting the signal to the wireless Internet access network.

The step (b) comprises: analyzing header information of a data frame included in the first communication type signal, and processing the same data frames in a predetermined order; converting the data frame into a format which corresponds to a MAC structure following the second communication type, and storing it in a temporary storage unit; and controlling a modulation rate and a bit rate and outputting the stored data frame according to the established modulation rate and the bit rate in order to transmit the data frame as a second communication type signal.

The step (e) comprises: analyzing header information of a data frame included in the second communication type signal, and processing the same data frames in a predetermined order; converting the data frame into a format which corresponds to a MAC structure following the first communication type, and storing it in a temporary storage unit; allocating a channel for the data frame; and controlling a modulation rate and a bit rate, controlling a data rate according to a difference between the established modulation rate and the bit rate, and outputting the data frame to the allocated channel in order to transmit the data frame as a first communication type signal.

The user terminal is operated in a first mode for transmitting and receiving signals in a first frequency band according to the first communication type, and a second mode for transmitting and receiving signals in a second frequency band according to the second communication type.

In still another aspect of the present invention, in a method for a user terminal to access a wireless Internet access network, a wireless Internet access method comprises: (a) operating the user terminal in a first mode to be accessed to the wireless Internet access network according to a first communication type; (b) determining whether the user terminal is located in the blanket area depending on a received state of the signal transmitted according to the first communication type; (c) searching for a repeater which supports mutual switching between the first and second communication types when the user terminal is found in the blanket area; and (d) operating the user terminal in a second mode to be accessed to the wireless Internet access network through the repeater according to the second communication type.

The first communication type is a wireless Internet access service type, and the second communication type Is a wireless local area network service type.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 shows a conceptual diagram of wireless Internet access repetition according to an exemplary embodiment of the present invention;

FIG. 2 shows a network structure diagram for wireless Internet access repetition according to an exemplary embodiment of the present invention;

FIG. 3 shows a structural diagram for a wireless Internet access repeater according to an exemplary embodiment of the present invention;

FIG. 4 shows a detailed structural diagram of an MAC conversion manager shown in FIG. 3; and

FIG. 5 shows an operational flowchart for a wireless Internet access repeater according to an exemplary embodiment of the present invention.

### DETAILED DESCRIPTION OF THE PREFERRED EMBODIMENTS

In the following detailed description, only the preferred embodiment of the invention has been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive. To clarify the present invention, parts which are not described in the specification are omitted, and parts for which similar descriptions are provided have the same reference numerals.

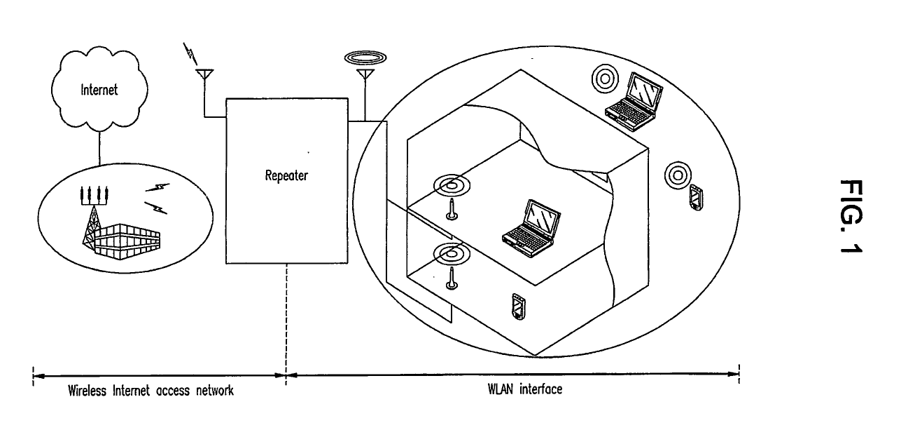

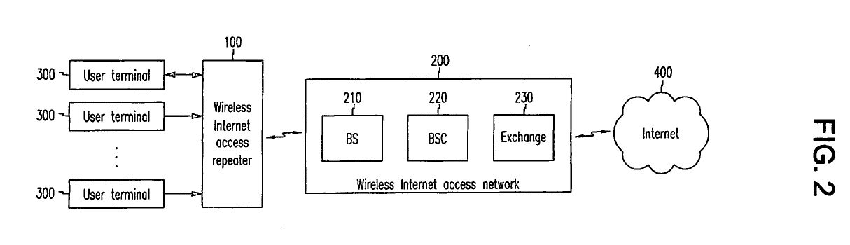

FIG. 1 shows a conceptual diagram of wireless Internet access repetition according to an exemplary embodiment of the present invention, and FIG. 2 shows a network structure diagram for wireless Internet access repetition according to an exemplary embodiment of the present invention.

As shown in FIG. 1, the wireless Internet access repeater according to the exemplary embodiment of the present invention transmits and receives signals to/from a wireless Internet access network according to a first communication type and transmits and receives them to/from a user terminal according to a second communication type so that the user may use the wireless Internet service. In particular, the wireless Internet access repeater converts MAC frames of the signals which are transmitted and received according to respective communication types into signals of other communication types, and manages and controls frame synchronization in order to repeat the signals according to the different communication types between the wireless Internet access network and the user terminal. In this instance, the first communication type includes a communication method which corresponds to the wireless Internet access service, and the second communication type includes a communication method which corresponds to the WLAN service. The wireless Internet access service is provided in the mobile communication, the IMT-2000, the portable Internet, and the next-generation mobile communication environments. The first and second communication types are not restricted to the above description.

As shown in FIG. 2, the wireless Internet access repeater 100 is coupled to a wireless Internet access network 200 and a plurality of user terminals 300.

The wireless Internet access network 200 comprises a plurality of base stations 210, a base station controller 220, and an exchange 230, and provides a packet data service according to a session connection request by the user terminal 300. No Internet service providing technique by the base stations 210, the base station controller 220, or the exchange 230 will be described since it is well known to a person skilled in the art.

The user terminal 300 is operable by a first mode or a second mode. In detail, the user terminal 300 is operated in the first mode to receive signals which are transmitted according to the first communication type and receive the wireless Internet service through the wireless Internet access network 200. Also, the user terminal 300 is operated in the second mode to receive the signals which are transmitted according to the second communication type and receive the wireless Internet service from the wireless Internet access network 200 through the repeater 100. The user terminal 300 operable in the dual modes includes a wireless LAN card which will not be described since it is known to a skilled person.

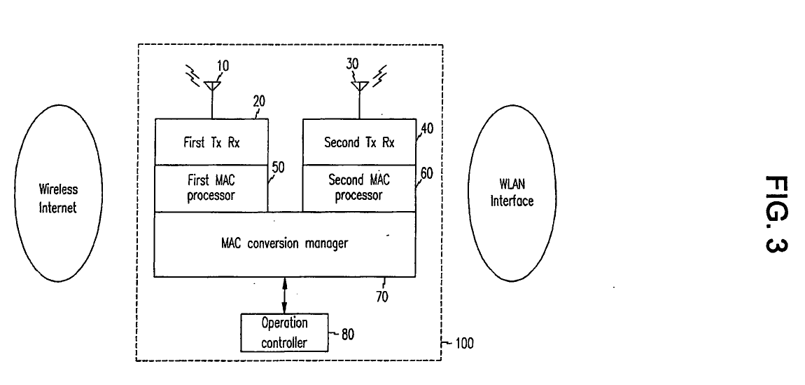

FIG. 3 shows a structural diagram of a wireless Internet access repeater 100 for the terminals wireless Internet access repetition according to an exemplary embodiment of the present invention.

As shown, the wireless Internet access repeater 100 comprises a doner antenna 10 for transmitting and receiving signals to/from the wireless Internet access network 200, a first transmit and receive unit 20 for transmitting and receiving signals through the doner antenna 10, a service antenna 30 for transmitting and receiving signals to/from the user terminal 300, a second transmit and receive unit 40 for transmitting and receiving signals through the service antenna 30, a first media access control (MAC) processor 50 for processing data frames transmitted and received through the first transmit and receive unit 20, a second MAC processor 60 for processing data frames transmitted and received through the second transmit and receive unit 40, an MAC conversion manager 70 for converting a format of the data frame according to a first communication type or a second communication type, and managing channels, and an operation controller 80 for controlling a repetition operation.

The first transmit and receive unit 20 processes forward signals transmitted from the wireless Internet access network 200 and received through the doner antenna 10 and transmits processed signals to the user terminal 300, thereby being operable as a forward signal processor. In particular, the first transmit and receive unit 20 transmits and receives signals to/from the base station 210 of the wireless Internet access network 200 in a frequency band of the first communication type. The second transmit and receive unit 40 processes reverse signals provided from the user terminal 300 and received through the service antenna 30 and transmits processed signals to the base station 210 of the wireless Internet access network 200, thereby being operable as a reverse signal processor, and in detail, it transmits and receives signals to/from the user terminal in a frequency band of the second communication type.

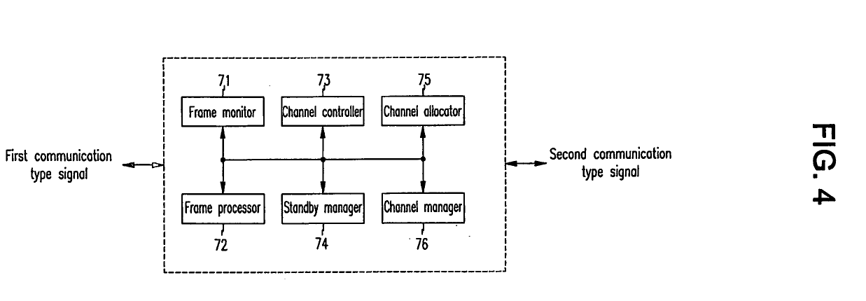

FIG. 4 shows a detailed configuration of the MAC conversion manager 70 which comprises a frame monitor 71 for managing order information of the same data frame according to header information of the transmitted and received data frames, a frame processor 72 for converting the data frame into an MAC structural format which corresponds to a communication type for transmitting the data frame, a channel controller 73 for controlling a modulation rate and a bit rate of the transmitted data frame according to the communication types, a standby manager 74 for controlling the data rates according to the established modulation rate and bit rate, a channel allocator 75 for allocating channels to the user terminal 300, and a channel manager 76 for managing channel allocation information and channel states.

An operation of the wireless Internet access repeater according to the exemplary embodiment of the present invention will be described based on the above-noted configuration.

The user terminal 300 is operated in the first mode in the areas other than the blanket area, periodically attempts to sense the pilot signals transmitted from the base station 210, and maintains transmission and receiving standby states. In this instance, the user terminal 300 receives the signals following the first communication type from the wireless Internet access network 200, and transmits the signals to the wireless Internet access network 200 according to the first communication type so that the user terminal 300 accesses the Internet 400 through the wireless Internet access network 200 and receives a wireless Internet service.

When moving from the area in which service is available and provided by the base station 210 to a service unavailable area such as the blanket area, the user terminal 300 is operated in the second mode and is accessed to the wireless Internet access repeater 100 (referred to as a repeater hereinafter.) In this case, the user terminal 300 can determine whether the user terminal 300 is located in the blanket area according to a signal-received state which follows the first communication type. For example, when the value received according to the first communication type is less than a predetermined value, the user terminal 300 is determined to be located in the blanket area, is operated in the second mode, and is accessed to the repeater 100. The terminal 300 searches for the repeater 100 in advance in the case of a blanket area, and can be operable in the second mode when the repeater 100 is found.

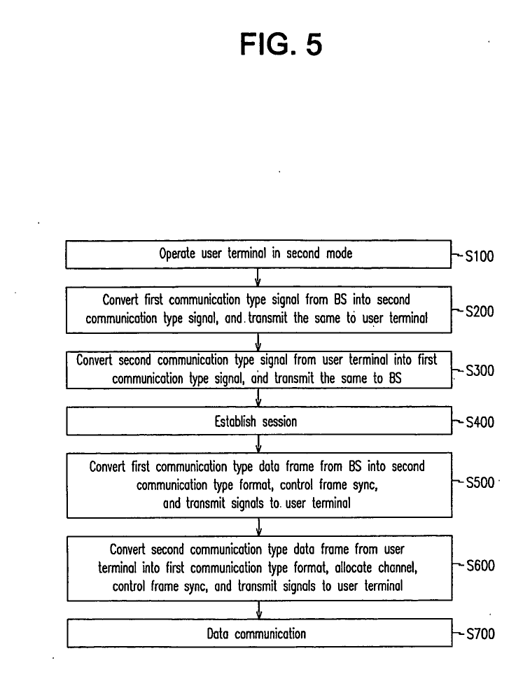

FIG. 5 shows an operation of the wireless Internet access repeater according to the exemplary embodiment of the present invention.

The signals which follow the first communication type transmitted from the wireless Internet access network 200, for example, a 2.3 GHz portable Internet service, are received by the doner antenna 10 of the S repeater 100, and the first transmit and receive unit 20 converts the radio frequency (RF) signals provided from the base station 210 of the wireless Internet access network 200 into low-frequency signals, and passes signals of the service frequency band to the second transmit and receive unit 40. The second transmit and receive unit 40 converts the provided signals into signals of a predetermined frequency band according to the second communication type such as the WLAN service, amplifies the converted signals, and transmits them to the user terminal 300 through the service antenna 30. Therefore, the user terminal 300 receives the second communication type signals from the repeater 100 through a wireless LAN card installed in the user terminal 300. Through this process, the signals transmitted from the wireless Internet access network 200 are transmitted to the user terminal 300 in steps S100 and S200.

When the user terminal 300 senses a pilot signal and requests packet data through a paging channel, the signals provided by the terminal 300 are received by the service antenna 30 and transmitted to the second transmit and receive unit 40. The second transmit and receive unit 40 converts the second communication type signals which are received through the service antenna 30 into low frequency signals, filters the signals of the corresponding band, and transmits them to the first transmit and receive unit 20 in a like manner of the abovedescribed first transmit and receive unit 20. The first transmit and receive unit 20 converts the received signals into the first communication type frequency band signals, and transmits the converted signals to the base station 210 through the doner antenna 10 in step S300.

The signals received by the base station 210 are transmitted to the exchange 230 through the base station controller 220, and the exchange 230 allocates a channel for packet data communication with the user terminal 300 so that the packet data communication (i.e., an Internet service) is performed between the base station 210 and the user terminal 300 in step S400.

The data packets transmitted from the base station 210 according to the first communication type are received by the doner antenna 10, processed by the first transmit and receive unit 20, and transmitted to the first MAC processor 50, and the first MAC processor 50 provides the transmitted data packets to the MAC conversion manager 70. The MAC conversion manager 70 then converts the format of the input data frame into a second communication type format according to control by the operation controller 80.

In detail, the frame monitor 71 of the MAC conversion manager 70 analyzes header information of the data frames input from the first MAC processor 50, and sequentially processes the same data frames, and the frame processor 72 converts the data frame into a format which corresponds to the MAC structure following the second communication type, and stores the same into a temporary storage unit of the standby manager 74. After this, the channel controller 73 controls the modulation rate and the bit rate in order to transmit the signals transmitted according to the first communication type as the signals which follow the second communication type, and the standby manager 74 controls the data rates according to differences of the modulation rates and the bit rates of the first and second communication types and outputs data frames to the second MAC processor 60 in step S500.

The data frame in the second communication type format transmitted from the second MAC processor 60 is processed to be the signals of the second communication type frequency band and transmitted to the user terminal 300 by the second transmit and receive unit 40.

Therefore, the user terminal 300 easily receives data from the base station without signal interference in the blanket area.

The second communication type data frame transmitted to the user terminal 300 is received by the service antenna 30 and the second transmit and receive unit 40, is transmitted to the MAC conversion manager 70 by the second MAC processor 60, is converted into the first communication type format, and is then transmitted to the base station 210.

That is, the frame monitor 71 of the MAC conversion manager 70 analyzes header information of the data frames input from the second MAC processor 60, and sequentially processes the same data frames, and the frame processor 72 converts the data frame into a format which corresponds to the MAC structure following the first communication type, and stores the same into a temporary storage unit of the standby manager 74. After this, the channel allocator 75 allocates a channel for the data frame transmitted from the user terminal 300, the channel controller 73 controls the modulation rate and the bit rate in order to transmit the signals transmitted according to the second communication type as the signals which follow the first communication type, and the standby manager 74 controls the data rates according to differences of the modulation rates and the bit rates of the first and second communication types and outputs data frames to the first MAC processor 50. Therefore, data frame synchronization between different communication types is performed in step S600.

The data frame in the first communication type format transmitted to the first MAC processor 50 is processed to be the signals in the first communication type frequency band (e.g., 2.3 GHz) and transmitted to the wireless Internet access network 200 by the first transmit and receive unit 20.

Since the signals and data are transmitted and received between the wireless Internet access network 200 and the user terminal 300 by using the different communication types according to the above-described method, interference between the signals with the same frequency is eliminated, and the user is allowed to easily receive the wireless Internet service in the blanket area in step S700.

The embodiment in which the wireless Internet access repeater transmits and receives signals to/from the user terminal 300 according to the second communication type has been described above, and in addition, it is possible for the repeater to transmit and receive signals to/from the user terminal according to the first communication type. That is, the repeater can have a dual function to transmit and receive signals to/from the user terminal according to different communication types, which will not be described since it is easily devised from the above-described embodiment.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

According to the present invention, the user is allowed to receive the Internet service using the wireless Internet access network anywhere.

In particular, the user can receive the wireless Internet service in the blanket area since signals and data based on different communication types are transmitted and received between the wireless Internet access network and the user terminal in the blanket area to thus eliminate interference between the signals with the same frequency.

What is claimed is:

1. In a device for repeating a wireless Internet access of a user terminal between a wireless Internet access network and the user terminal, a wireless Internet access repeater comprising:
a first transmit and receive unit for transmitting receiving signals to/from the wireless Internet access network by a first communication type;
a second transmit and receive unit for transmitting receiving signals to/from the user terminal by a second communication type; and
a media access control (MAC) conversion manager for processing data included in the first communication type signal input by the first transmit and receive unit into a second communication type format, transmitting the second communication type format data to the second transmit and receive unit, processing data included in the second communication type signal input by the second transmit and receive unit into a first communication type format, and transmitting the first communication type format data to the first transmit and receive unit.

2. The wireless Internet access repeater of claim 1, further comprising an operation controller for controlling the MAC conversion manager and controlling transmitting and receiving repetition of the signals which are transmitted according to the first and second communication types.

3. The wireless Internet access repeater of claim 1, wherein the MAC conversion manager comprises:
a frame monitor for managing order information of the same data frame according to header information of the data frame included in the signals received by the first or second transmit and receive unit;
a frame processor for converting the data frame into a format which follows a MAC structure corresponding to a desired communication type;
a channel controller for controlling a modulation rate and a bit rate of the transmitted data frame according to the communication type; and
a standby manager for controlling data rates according to the established modulation rate and the bit rate.

4. The wireless Internet access repeater of claim 3, wherein the MAC conversion manager further comprises:
a channel allocator for allocating a channel to the data frame included in the signal received through the second transmit and receive unit; and
a channel manager for managing channel allocation information and channel states.

5. The wireless Internet access repeater of claim 1, further comprising:
a first MAC processor for repeating transmission of the data frame between the MAC conversion manager and the first transmit and receive unit; and
a second MAC processor for repeating transmission of the data frame between the MAC conversion manager and the second transmit and receive unit.

6. The wireless Internet access repeater of claim 1, wherein the user terminal is operated in a first mode for transmitting and receiving signals in a first frequency band according to the first communication type, and a second mode for transmitting and receiving signals in a second frequency band according to the second communication type.

7. The wireless Internet access repeater of claim 1, wherein the first communication type is a wireless Internet access service type, and the second communication type is a wireless local area network service type.

8. The wireless Internet access repeater of claim 7, wherein the first communication type is a communication type which follows the 2.3 GHz portable Internet service.

9. The wireless Internet access repeater of claim 1, wherein the wireless Internet access repeater is located in a blanket area.

10. In a method for repeating a wireless Internet access of a user terminal between a wireless Internet access network and the user terminal, a wireless Internet access repetition method comprising:
(a) receiving a signal in a first frequency band following a first communication type and being transmitted from the wireless Internet access network;
(b) converting the received signal into a second communication type format;
(c) processing the converted signal into a signal in a second frequency band following the second communication type, and transmitting the processed signal to the user terminal;
(d) receiving a signal in a second frequency band following the second communication type and being transmitted from the user terminal;
(e) converting the received signal into the first communication type format; and
(f) processing the converted signal into a signal in the first frequency band according to the first communication type, and transmitting the signal to the wireless Internet access network.

11. The wireless Internet access repetition method of claim 10, wherein the first communication type is a wireless Internet access service type, and the second communication type is a wireless local area network service type.

12. The wireless Internet access repetition method of claim 10, wherein (b) comprises:
analyzing header information of a data frame included in the first communication type signal, and processing the same data frames in a predetermined order;
converting the data frame into a format which corresponds to a MAC structure following the second communication type, and storing it in a temporary storage unit; and
controlling a modulation rate and a bit rate and outputting the stored data frame according to the established modulation rate and the bit rate in order to transmit the data frame as a second communication type signal.

13. The wireless Internet access repetition method of claim 10, wherein (e) comprises:
analyzing header information of a data frame included in the second communication type signal, and processing the same data frames in a predetermined order;
converting the data frame into a format which corresponds to a MAC structure following the first communication type, and storing it in a temporary storage unit;
allocating a channel for the data frame; and
controlling a modulation rate and a bit rate, controlling a data rate according to a difference between the established modulation rate and the bit rate, and outputting the data frame to the allocated channel in order to transmit the data frame as a first communication type signal.

14. The wireless Internet access repetition method of claim 10, wherein the wireless Internet access repetition method repeats the wireless Internet access of the user terminal located in a blanket area.

15. In a method for a user terminal to access a wireless Internet access network, a wireless Internet access method comprising:
(a) operating the user terminal in a first mode to be accessed to the wireless Internet access network according to a first communication type;
(b) determining whether the user terminal is located in the blanket area depending on a received state of the signal transmitted according to the first communication type;
(c) searching for a repeater which supports mutual switching between the first and second communication types when the user terminal is found in the blanket area; and
(d) operating the user terminal in a second mode to be accessed to the wireless Internet access network through the repeater according to the second communication type.

16. The wireless Internet access method of claim 15, wherein the first communication type is a wireless Internet access service type, and the second communication type is a wireless local area network service type.

17. The wireless Internet access method of claim 16, wherein the first communication type is a communication type which follows the 2.3 GHz portable Internet service.
